(19) United States
(12) Patent Application Publication
(10) Pub. No.: US 2023/0267208 A1
(43) Pub. Date: Aug. 24, 2023

(54) METHOD AND SYSTEM FOR PROACTIVELY PROVIDING FIXES FOR VULNERABILITIES OF AN APPLICATION UPGRADE WHILE PERFORMING THE APPLICATION UPGRADE

(71) Applicant: Dell Products L.P., Round Rock, TX (US)

(72) Inventors: Parminder Singh Sethi, Ludhiana (IN); Lakshmi Saroja Nalam, Bangalore (IN); Shelesh Chopra, Bangalore (IN)

(21) Appl. No.: 17/582,522

(22) Filed: Jan. 24, 2022

(51) Int. Cl. G06F 21/56; G06F 21/57

(52) U.S. Cl. CPC G06F 21/568; G06F 21/577; G06F 2221/033

(57) ABSTRACT

In general, embodiments relate to a method for performing an application upgrade, comprising: receiving an application upgrade request to upgrade an application to a specific version from a client device; sending information related to the application upgrade to a vulnerability validator; determining, based on impact score information, that the specific version of the application has vulnerabilities; identifying, based on the determining, at least one fix for at least one of the vulnerabilities; generating an application upgrade package based on the specific version of the application and the at least one fix; and providing the application upgrade package to a client device upgrade manager.

### BACKGROUND

Computing devices in a system may include any number of internal components such as processors, memory, and persistent storage. The computing devices may execute applications (e.g., software). Each application may be upgraded to newer versions to protect the computing devices from security vulnerabilities of the application.

### BRIEF DESCRIPTION OF DRAWINGS

Certain embodiments of the invention will be described with reference to the accompanying drawings. However, the accompanying drawings illustrate only certain aspects or implementations of the invention by way of example, and are not meant to limit the scope of the claims.

FIG. 1 shows a diagram of a system in accordance with one or more embodiments of the invention.

FIG. 2 shows a diagram of a device emulation system in accordance with one or more embodiments of the invention.

FIG. 3 shows a method to proactively provide fixes for vulnerabilities of an application upgrade in accordance with one or more embodiments of the invention.

FIG. 4 shows a diagram of a forest tree database in accordance with one or more embodiments of the invention.

FIG. 5 shows a diagram of a computing device in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

In general, a user of a client device (e.g., computing device) is unaware about whether an application upgrade has vulnerabilities and/or is at risk while performing the application upgrade. Embodiments of the invention relate to a method and system for proactively providing fixes for vulnerabilities of an application upgrade while performing the application upgrade. More specifically, various embodiments of the invention receive an application upgrade request to upgrade an application to a specific version from a client device and send this information related to the application upgrade to a vulnerability validator. The vulnerability validator determines whether that specific version of the application has vulnerabilities and based on the determination, at least one fix for at least one of the vulnerabilities is identified. Further, an application upgrade package based on the specific version of the application and the at least one fix is generated, and this application upgrade package is provided to a client device upgrade manager. The client device upgrade manager initiates the application upgrade and the at least one fix on the client device.

The following describes various embodiments of the invention.

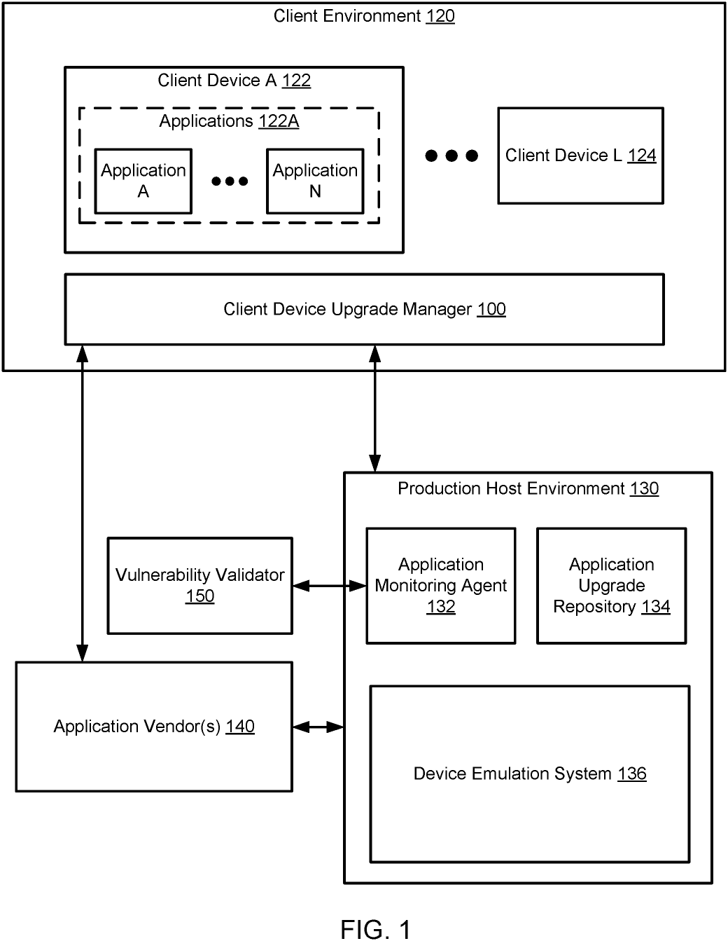

FIG. 1 shows a diagram of a system in accordance with one or more embodiments of the invention. The system includes a client environment (120), one or more application vendors (140), and a production host environment (130). The system may include additional, fewer, and/or different components without departing from the invention. Each component may be operably connected to any of the other component via any combination of wired and/or wireless connections. Each component illustrated in FIG. 1 is discussed below.

In one or more embodiments of the invention, the client environment (120) includes client devices (e.g., 122, 124, etc.) and a client device upgrade manager (100). Each client device (e.g., 122, 124, etc.) may include applications (e.g., 122A). The applications (e.g., 122A) may be logical entities executed using computing resources (not shown) of the client devices (e.g., 122, 124, etc.). Each of the applications may perform similar or different processes. In one or more embodiments of the invention, the applications (e.g., 122A) provide services to users, e.g., clients (not shown). For example, the applications (e.g., 122A) may host components. The components may be, for example, instances of databases, email servers, and/or other components. The applications (e.g., 122A) may host other types of components without departing from the invention. The applications (e.g., 122A) may be executed on one or more client devices (e.g., 122, 124, etc.) as instances of the application.

The applications (e.g., 122A) may be upgraded based on newer versions available for installation. The installation of application upgrades may be performed and/or otherwise initiated by the client device upgrade manager (100). In one or more embodiments of the invention, the client device upgrade manager (100) may periodically collect information (e.g., device state and configuration information, operating system version, application(s) installed, etc.) from the client devices (e.g., 122, 124, etc.) and may send this information to the application vendor(s) (140) for technical support (e.g., recommendations and/or fixes for hardware and/or software failures) to the client devices (e.g., 122, 124, etc.). Further, when there is an application upgrade that is available to fix critical application related issues, the client device upgrade manager (100) may identify the client devices (e.g., 122, 124, etc.) that require the application upgrade and the application vendor(s) (140) may provide a catalog file(s) that specifies the requirements of the identified client device(s) to the production host environment (130).

In one or more embodiments of the invention, the application upgrade repository (134) stores versions of the application upgrade(s). The application upgrade repository (134) may be updated by the application vendor(s) (140) based on the new versions of the application upgrades being available. The application upgrade repository (134) may further include catalog files in order for the application upgrade to be installed. The requirements may include, for example, a compatible device model, a minimum application version for the application upgrade to be installed, a compatible operating system (and corresponding version of such operating system), and an update sequence.

In one or more embodiments of the invention, the client device upgrade manager (100) may obtain application upgrade estimations that specify the required estimated time that the application upgrade may take. The client device upgrade manager (100) may provide the required estimated time for the application upgrade and optimal time slots in which the application upgrade may be performed.

In one or more embodiments of the invention, an application monitoring agent (132) can push the application upgrade(s) to the client device upgrade manager (100). In one or more embodiments of the invention, the application monitoring agent (132) may obtain a list of the client devices (e.g., 122, 124, etc.) that are managed by the client device upgrade manager (100) and the information related to the application(s) installed to those client devices from the client device upgrade manager. In one or more embodiments of the invention, the application monitoring agent (132) may identify a target client device (e.g., 122, 124, etc.) that is compatible with the application upgrade(s) based on the catalog file available in the application upgrade repository (134). Further, in response to a new application upgrade, the application monitoring agent (132) may initiate an estimation of performing the application upgrade on one or more of the client devices (e.g., 122, 124, etc.). The upgrade estimation(s) may be provided to the client device upgrade manager (100).

In one or more embodiments of the invention, the application upgrade may further include functionality for monitoring device configuration information of the client devices (e.g., 122, 124, etc.) such as operating system information, number of applications, current versions of such applications, processing power, memory capability, storage, etc. The device configuration information may be provided to the production host environment (130).

In one or more embodiments of the invention, the applications (e.g., 122A) are implemented as computer instructions, e.g., computer code, stored on a persistent storage that when executed by a processor(s) of a computing device cause the computing device (not shown) to provide the functionality of the applications described throughout this application.

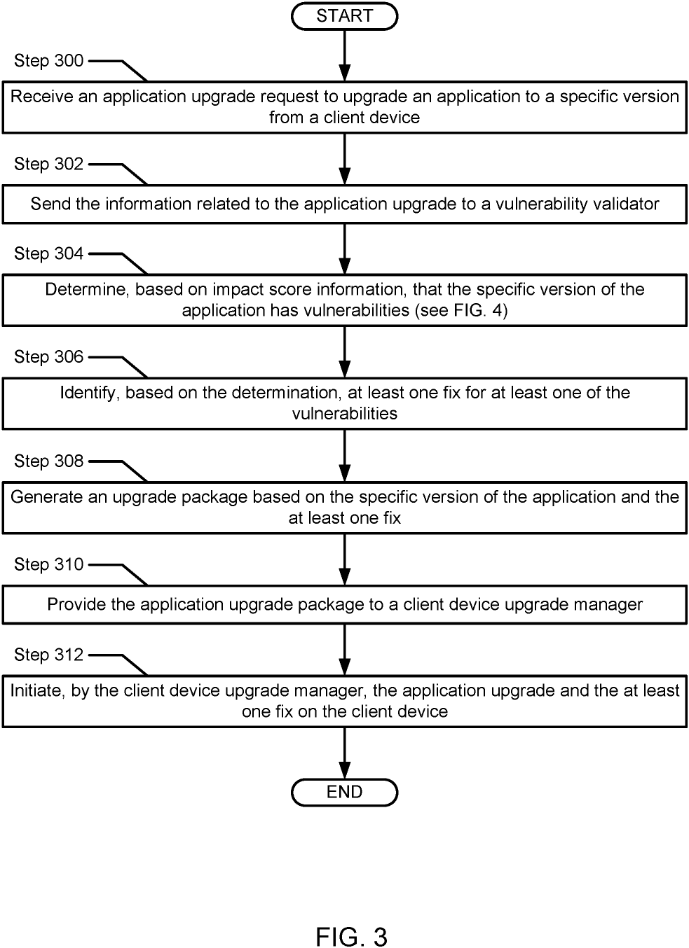

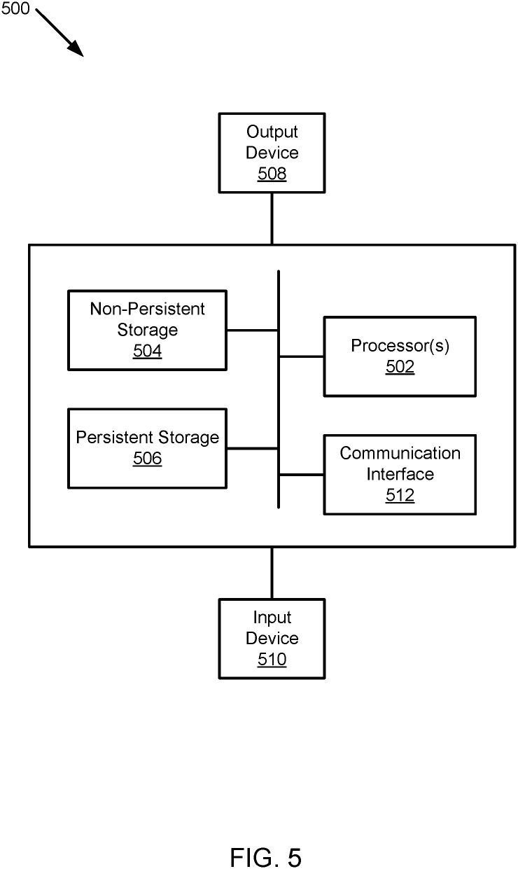

In one or more embodiments of the invention, the client device upgrade manager (100) is implemented as a computing device (see, e.g., FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the client device upgrade manager (100) described throughout this application and/or all, or a portion thereof, of the method illustrated in FIG. 3.

In one or more embodiments of the invention, the client device upgrade manager (100) is implemented as a logical device. The logical device may utilize the computing resources of any number of computing devices and thereby provide the functionality of the client device upgrade manager (100) described throughout this application and/or all, or a portion thereof, of the methods illustrated in FIG. 3.

In one or more embodiments of the invention, the production host environment (130) estimates the upgrade times and required reboots to perform the application upgrade(s). The production host environment (130) may include the application monitoring agent (132), the application upgrade repository (134), and a device emulation system (136). The production host environment (130) may include additional, fewer, and/or different components without departing from the invention.

In one or more embodiments of the invention, the application monitoring agent (132) is implemented as a computing device (see, e.g., FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the application monitoring agent (132) described throughout this application and/or all, or a portion thereof, of the method illustrated in FIG. 3.

In one or more embodiments of the invention, the application monitoring agent (132) is implemented as a logical device. The logical device may utilize the computing resources of any number of computing devices and thereby provide the functionality of the application monitoring agent (132) described throughout this application and/or all, or a portion thereof, of the methods illustrated in FIG. 3.

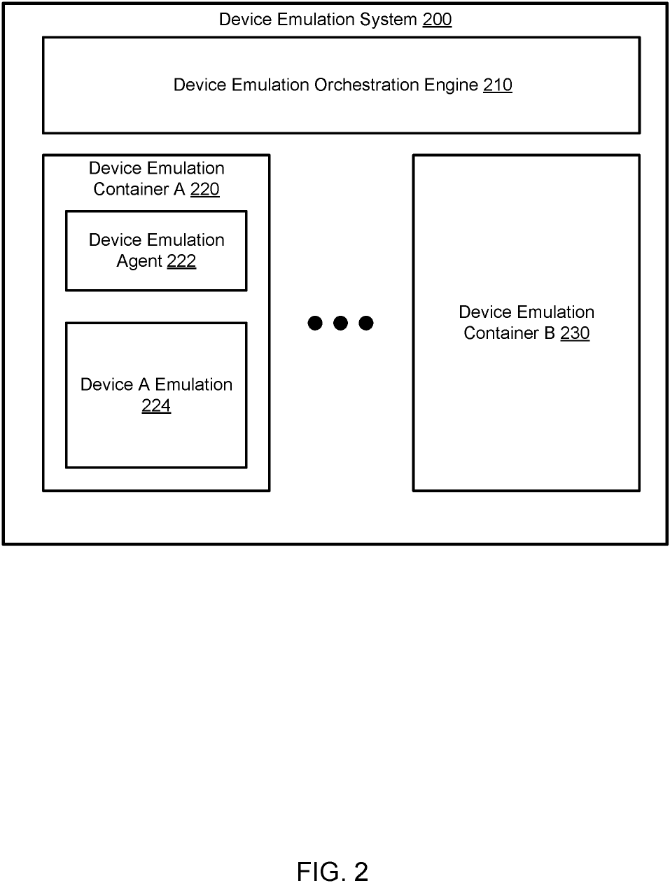

In one or more embodiments of the invention, the device emulation system (136) is a system of device emulation containers that may be configured to emulate the client device (e.g., 122, 124, etc.). The emulation of the client devices may be used for performing the application upgrades on the emulated devices and measuring upgrade metrics such as time taken, number of reboots required, etc. For additional details regarding the device emulation system (136), see, e.g., FIG. 2.

In one or more embodiments of the invention, the device emulation system (136) is implemented as a computing device (see, e.g., FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the device emulation system (136) described throughout this application and/or all, or a portion thereof, of the methods illustrated in FIG. 3.

In one or more embodiments of the invention, the device emulation system (136) is implemented as a logical device. The logical device may utilize the computing resources of any number of computing devices and thereby provide the functionality of the device emulation system (136) described throughout this application and/or all, or a portion thereof, of the methods illustrated in FIG. 3.

In one or more embodiments of the invention, the production host environment (130) is implemented as a computing device (see, e.g., FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the production host environment (130) described throughout this application.

In one or more embodiments of the invention, the production host environment (130) is implemented as a logical device. The logical device may utilize the computing resources of any number of computing devices and thereby provide the functionality of the production host environment (130) described throughout this application.

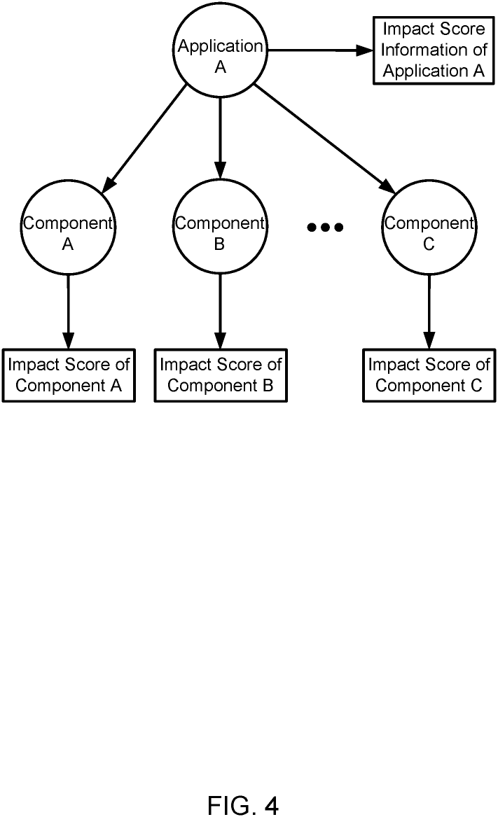

In one or more embodiments of the invention, a vulnerability validator (150) determines vulnerabilities of the application upgrade and/or an application installed to the client device (e.g., 122, 124, etc.). In one or more embodiments of the invention, the vulnerability validator (150) includes a forest tree database (see FIG. 4), in which the forest tree database includes an impact score information of the application installed and an impact score of a subcomponent(s) of the application installed. Further, the forest tree database includes information related to the application installed such as the application version information of the application installed. Additional detail about the operation of the vulnerability validator (150) is provided below, e.g., in FIG. 4. Those skilled in the art will appreciate that the invention is not limited to the use of a forest tree database; rather, any data structure may be used by the vulnerability validator without departing from the invention.

In one or more embodiments of the invention, the vulnerability validator (150) is implemented as a computing device (see, e.g., FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the vulnerability validator (150) described throughout this application.

In one or more embodiments of the invention, the vulnerability validator (150) is implemented as a logical device. The logical device may utilize the computing resources of any number of computing devices and thereby provide the functionality of the vulnerability validator (150) described throughout this application.

Turning now to FIG. 2, FIG. 2 shows a diagram of a device emulation system in accordance with one or more embodiments of the invention. The device emulation system (200) may be an embodiment of the device emulation system (e.g., 136, FIG. 1) discussed above, in which the device emulation system emulates the client devices (e.g., 122, 124, etc., FIG. 1). The device emulation system (200) may include a device emulation orchestration engine (210) and one or more device emulation containers (e.g., 220, 230). The device emulation system (200) may include additional, fewer, and/or different components without departing from the invention.

In one or more embodiments of the invention, the device emulation orchestration engine (210) orchestrates the generation of the device emulation containers (e.g., 220, 230). The device emulation orchestration engine (210) may obtain requests to emulate the application upgrade on an emulated device and to provide obtained upgrade estimations to the production host environment (e.g., 130, FIG. 1). The device emulation orchestration engine (210) may initiate the emulation of the devices and the application upgrade(s).

In one or more embodiments of the invention, the device emulation orchestration engine (210) is implemented as a computing device (see, e.g., FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the device emulation orchestration engine (210) described throughout this application.

In one or more embodiments of the invention, the device emulation orchestration engine (210) is implemented as a logical device. The logical device may utilize the computing resources of any number of computing devices and thereby provide the functionality of the device emulation orchestration engine (210) described throughout this application.

In one or more embodiments of the invention, the device emulation containers (e.g., 220, 230) include a device emulation agent (222) that monitors the application upgrade(s) performed on an emulated device (e.g., 224) of the device emulation container (e.g., 220, 230) to measure the time taken to perform each application upgrade and to track the number of reboots performed during the application upgrade.

This information may then be used to evaluate potential application upgrades and, based on this evaluation, determine whether one or more application upgrades should be push out to the one or more client devices.

FIG. 3 shows a flowchart in accordance with one or more embodiments of the invention. While the various steps in the flowchart are presented and described sequentially, one of ordinary skill in the relevant art will appreciate that some or all of the steps may be executed in different orders, may be combined or omitted, and some or all steps may be executed in parallel without departing from the scope of the invention.

Turning now FIG. 3, FIG. 3 shows a method to proactively provide fixes for vulnerabilities of an application upgrade in accordance with one or more embodiments of the invention. The method shown in FIG. 3 may be performed by, for example, the client device upgrade manager (e.g., 100, FIG. 1), the application monitoring agent (e.g., 132, FIG. 1), the vulnerability validator (e.g., 150, FIG. 1), and/or the device emulation orchestration engine (e.g., 210, FIG. 2). Other components of the system illustrated in FIG. 1 may perform the method of FIG. 3 without departing from the invention.

In Step 300, an application upgrade request to upgrade an application to a specific version from a client device is received. In one or more embodiments of the invention, the application upgrade request to upgrade the application to the specific version from the client device may be received by the client device upgrade manager (e.g., 100, FIG. 1). The device configuration information of the client device (e.g., 122, 124, etc., FIG. 1) may be obtained prior to receiving the application upgrade request to upgrade the application to the specific version from the client device.

In one or more embodiments of the invention, information related to the application upgrade may include, but it is not limited to, application version information of the application upgrade. The information related to the application upgrade may include other details related to the application upgrade without departing from the invention.

In one or more embodiments of the invention, the device configuration information of the client device (e.g., 122, 124, etc., FIG. 1) may specify the configuration of a set of client devices that requested the application upgrade. The configuration may be associated with, for example, a current version of the operating system of the client device (e.g., 122, 124, etc., FIG. 1), the number of processors (e.g., central processing unit), the amount of memory available for the client device, a number of applications executing on the client device, and the amount of available persistent storage of the client device. Other configurations may be specified in the device configuration information without departing from the invention.

In Step 302, the information related to the application upgrade is sent to the vulnerability validator (e.g., 150, FIG. 1). In one or more embodiments of the invention, the client device upgrade manager (e.g., 100, FIG. 1) sends the information related to the application upgrade to the application monitoring agent (e.g., 132, FIG. 1), which further sends the information related to the device emulation orchestration engine (e.g., 210, FIG. 2). The device emulation orchestration engine (e.g., 210, FIG. 2) may in turn send the information related to the application upgrade to the vulnerability validator (e.g., 150, FIG. 1).

Continuing the discussion of FIG. 3, in Step 304, based on impact score information, whether the specific version of the application has vulnerabilities is determined. In one or more embodiments of the invention, based on impact score information, whether the specific version of the application has vulnerabilities is determined by the vulnerability validator (e.g., 150, FIG. 1)

In one or more embodiments of the invention, for example, the information related to the application upgrade may specify that client device A has requested to upgrade version two of application A and client device L has requested to upgrade version three of the application A. The vulnerability validator (e.g., 150, FIG. 1) will perform an analysis to calculate the impact score information of each application upgrade request and determine whether the requested application upgrades have vulnerabilities. For additional detail regarding the calculation of the impact score information and the determination process, see, e.g., FIG. 4.

In Step 306, based on the determination result from Step 304, at least one fix for at least one of the vulnerabilities is identified. In one or more embodiments of the invention, the least one fix for at least one of the vulnerabilities is identified and provided by the device emulation orchestration engine (e.g., 210, FIG. 2) as a part of an upgrade strategy.

In Step 308, an application upgrade package based on the specific version of the application and the at least one fix is generated. In one or more embodiments of the invention, the application upgrade package based on the specific version of the application and the at least one fix is generated (or otherwise provided) by the device emulation orchestration engine (e.g., 210, FIG. 2). In one embodiment of the invention, the fix corresponds to a software fix(es) to be installed on the client device, a script to executed on the client device, information about how to modify the configuration of the client device to address the vulnerability, or any combination thereof.

In one embodiment of the invention, the device emulation orchestration engine (e.g., 210, FIG. 2) includes or otherwise has access to data structure that specific which fixes may be appropriate for which vulnerabilities. For example, if it is determined that the upgrade for application A needs to be fixed, then the device emulation orchestration engine (e.g., 210, FIG. 2) may use a unique identifier for upgrade of application A to determine any related fixes.

The device emulation orchestration engine may emulate the performance of the at least one fix (e.g., emulate the installation of an application fix(es)) to determine whether the at least one fix can be successfully installed on the client device.

In Step 310, the application upgrade package generated in Step 308 is provided to the client device upgrade manager (e.g., 100, FIG. 1).

In Step 312, the application upgrade and the at least one fix on the client device is initiated. In one or more embodiments of the invention, the application upgrade and the at least one fix on the client device is initiated by the client device upgrade manager (e.g., 100, FIG. 1).

The method ends following Step 312.

Turning now FIG. 4, FIG. 4 shows a diagram of a forest tree database in accordance with one or more embodiments of the invention. In one or more embodiments of the invention, the forest tree specifies, for a given client device, an application upgrade (e.g., application A) and a subcomponent(s) (e.g., component A, component B, component C, etc.) of the application upgrade. In one or more embodiments of the invention, the subcomponent(s) of the application upgrade include, but are not limited to dynamically linked libraries and/or archive files.

In one or more embodiments of the invention, based on the impact score information (e.g., impact score information of application A), the vulnerability validator (e.g., 150, FIG. 1) determines whether a specific version of the application upgrade has vulnerabilities. In one or more embodiments of the invention, the vulnerability validator (e.g., 150, FIG. 1) calculates the vulnerability of the application upgrade based on a scoring system (e.g., common vulnerability scoring system). Further, in one or more embodiments of the invention, while performing the calculation, the vulnerability validator (e.g., 150, FIG. 1) takes into account one or more impact factor parameters such as attack vector, attack complexity, base score, and base severity.

Those skilled in the art will appreciate that while the above impact factor parameters are taken into account to perform the calculation, any other impact factor parameter may be used to calculate the vulnerability of the application upgrade without departing from the invention.

In one or more embodiments of the invention, the scoring system takes into account the impact score of the subcomponent(s) of the application upgrade to generate the impact score information. For example, in one embodiment of the invention, for version two of application A (e.g., the requested application upgrade version), the impact score of subcomponent A is 90%, the impact score of subcomponent B is 95%, and the impact score of subcomponent C is 95%. The average of the impact score of the subcomponent(s) of the application upgrade is determined and compared against a predetermined impact score information threshold (e.g., less than or equal to 90%). If the average of the impact score of the subcomponent(s) of the application upgrade is below the predetermined impact score information threshold, then the vulnerability validator classifies the application upgrade as having vulnerabilities. For the version two of application A, the average of the impact score of the subcomponent(s) of the application upgrade is 93.3%, which is above the predetermined impact score information threshold and, thus, the application upgrade is classified as having no vulnerabilities.

In another embodiment of the invention, for version three of application A (e.g., the requested application upgrade version), the impact score of subcomponent A is 90%, the impact score of subcomponent B is 95%, and the impact score of subcomponent C is 75%. For the version three of application A, the average of the impact score of the subcomponent(s) of the application upgrade is 86.7%, which is below the predetermined impact score information threshold and, thus, the application upgrade to the version three of application A is classified as having vulnerabilities.

In another embodiment of the invention, for version four of application A (e.g., the requested application upgrade version), the impact score of subcomponent A is 95%, the impact score of subcomponent B is 95%, and the impact score of subcomponent C is 95%. For the version four of application A, the average of the impact score of the subcomponent(s) of the application upgrade is 95%, which is above the predetermined impact score information threshold and, thus, the application upgrade to the version four of application A is classified as having no vulnerabilities.

In one or more embodiments of the invention, based on the examples provided above, the request to application upgrade version three of the application A may not be performed, because the version three of the application A has vulnerabilities. In one or more embodiments of the invention, to perform this application upgrade, at least one fix will be identified and will be provided to the client device upgrade manager (e.g., 100, FIG. 1) as an application upgrade package for this application upgrade request.

Those skilled in the art will appreciate that while the common vulnerability scoring system is used as the scoring system to calculate the vulnerabilities of the specific version of the application, any other scoring system may be used to calculate the vulnerabilities of the specific version of the application without departing from the invention.

Further, those skilled in the art will appreciate that while the forest tree database is described above with respect to including a single installed application, the forest tree database includes information related to multiple applications and multiple versions of the same application along with their corresponding subcomponents.

Turning now to FIG. 5, FIG. 5 shows a diagram of a computing device in accordance with one or more embodiments of the invention.

In one or more embodiments of the invention, the computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), an input device(s) (510), an output device(s) (508), and numerous other elements (not shown) and functionalities. Each of these components is described below.

In one or more embodiments, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (not shown) (e.g., a local area network (LAN), a wide area network (WAN), such as the Internet, mobile network, or any other type of network) and/or to another device, such as another computing device.

In one or more embodiments, the computing device (500) may include one or more output devices (508), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

The problems discussed above should be understood as being examples of problems solved by embodiments described herein, and the various embodiments should not be limited to solving the same/similar problems. The disclosed embodiments are broadly applicable to address a range of problems beyond those discussed herein.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for performing an application upgrade, the method comprising:
receiving an application upgrade request to upgrade an application to a specific version from a client device;
sending information related to the application upgrade to a vulnerability validator;
determining, based on impact score information, that the specific version of the application has vulnerabilities;
identifying, based on the determining, at least one fix for at least one of the vulnerabilities;
generating an application upgrade package based on the specific version of the application and the at least one fix; and
providing the application upgrade package to a client device upgrade manager.

2. The method of claim 1, wherein the vulnerability validator determines vulnerabilities of the specific version of the application.

3. The method of claim 1, wherein the vulnerability validator comprises a forest tree database, wherein the forest tree database comprises an impact score of a subcomponent of the application upgrade.

4. The method of claim 3, wherein impact score information is calculated based on the impact score of the subcomponent of the application upgrade.

5. The method of claim 3, wherein the subcomponent of the application upgrade is a dynamically linked library or an archive file.

6. The method of claim 1, wherein the information related to the application upgrade comprises application version information of the application upgrade.

7. The method of claim 1, wherein the client device upgrade manager receives the application upgrade request to upgrade the application to the specific version from the client device.

8. A non-transitory computer readable medium comprising computer readable program code, which when executed by a computer processor enables the computer processor to perform a method for performing an application upgrade, the method comprising:
receiving an application upgrade request to upgrade an application to a specific version from a client device;
sending information related to the application upgrade to a vulnerability validator;
determining, based on impact score information, that the specific version of the application has vulnerabilities;
identifying, based on the determining, at least one fix for at least one of the vulnerabilities;
generating an application upgrade package based on the specific version of the application and the at least one fix; and
providing the application upgrade package to a client device upgrade manager.

9. The non-transitory computer readable medium of claim 8, wherein the vulnerability validator determines vulnerabilities of the specific version of the application.

10. The non-transitory computer readable medium of claim 8, wherein the vulnerability validator comprises a forest tree database, wherein the forest tree database comprises an impact score of a subcomponent of the application upgrade.

11. The non-transitory computer readable medium of claim 10, wherein impact score information is calculated based on the impact score of the subcomponent of the application upgrade.

12. The non-transitory computer readable medium of claim 10, wherein the subcomponent of the application upgrade is a dynamically linked library or an archive file.

13. The non-transitory computer readable medium of claim 8, wherein the information related to the application upgrade comprises application version information of the application upgrade.

14. The non-transitory computer readable medium of claim 8, wherein the client device upgrade manager receives the application upgrade request to upgrade the application to the specific version from the client device.

15. A system for performing an application upgrade, the system comprising:
a processor comprising circuitry;
memory comprising instructions, which when executed perform a method, the method comprising:
receiving an application upgrade request to upgrade an application to a specific version from a client device;
sending information related to the application upgrade to a vulnerability validator;
determining, based on impact score information, that the specific version of the application has vulnerabilities;
identifying, based on the determining, at least one fix for at least one of the vulnerabilities;
generating an application upgrade package based on the specific version of the application and the at least one fix; and
providing the application upgrade package to a client device upgrade manager.

16. The system of claim 15, wherein the vulnerability validator determines vulnerabilities of the specific version of the application.

17. The system of claim 15, wherein the vulnerability validator comprises a forest tree database, wherein the forest tree database comprises an impact score of a subcomponent of the application upgrade.

18. The system of claim 17, wherein impact score information is calculated based on the impact score of the subcomponent of the application upgrade.

19. The system of claim 17, wherein the subcomponent of the application upgrade is a dynamically linked library or an archive file.

20. The system of claim 15, wherein the information related to the application upgrade comprises application version information of the application upgrade.
